(19) United States
(12) Patent Application Publication
(10) Pub. No.: US 2026/0364831 A1
(43) Pub. Date: Nov. 19, 2026

(54) DUAL-PURPOSE RAZOR HEAD STRUCTURE AND HAIR TRIMMER

(71) Applicant: NINGBO UNIBONO APPLIANCE CO., LTD, Ningbo (CN)

(72) Inventors: Jianfeng YAN, Ningbo (CN); Yang SHEN, Ningbo (CN)

(73) Assignee: NINGBO UNIBONO APPLIANCE CO., LTD, Ningbo (CN)

(21) Appl. No.: 19/533,370

(22) Filed: Feb. 9, 2026

(30) Foreign Application Priority Data
Mar. 17, 2025 (CN) 202520471577.4

(51) Int. Cl. B26B 19/10

(52) U.S. Cl. CPC B26B 19/10

(57) ABSTRACT

A dual-purpose razor head structure and a hair trimmer, the dual-purpose razor head structure including an oscillating frame for connection to a motor shaft, a stationary blade holder and a movable blade assembly being connected to the oscillating frame; the oscillating frame being connected to the movable blade assembly and driving the movable blade assembly to reciprocate; a first trimming part for shortening hair and a second trimming part for shaving the hair roots being formed between the movable blade assembly and the stationary blade holder; the first trimming part including stationary blade teeth on the stationary blade holder and movable blade teeth on the movable blade assembly, with the stationary blade teeth cooperating with the movable blade teeth; the second trimming part including a stationary blade mesh on the stationary blade holder and a shaving blade strip on the movable blade assembly.

### RELATED APPLICATIONS

This application claims priority to Chinese Patent Application No. 202520471577.4, filed on Mar. 17, 2025, with Chinese Patent Office. The entire contents of the aforementioned application are incorporated herein by reference.

### TECHNICAL FIELD

The present disclosure relates to the technical field of hair trimmers, and in particular, to a dual-purpose razor head structure and a hair trimmer.

### BACKGROUND ART

Reciprocating hair trimmers drive a movable blade to perform reciprocating motion by means of an oscillating motor, whereby the movable blade cooperates with a stationary blade holder to trim hair. Some existing reciprocating hair trimmers are provided with only a single trimming part for shortening hair, that is, they only have the function of cutting hair to a shorter length. Such trimmers have relatively limited functionality and are inconvenient for trimming hair at the roots. As a result, users need to additionally use a dedicated shaving trimmer to trim hair at the roots, which results in cumbersome operation and low hair-trimming efficiency. In addition, some existing reciprocating hair trimmers have relatively complex structures, resulting in a razor head structure with a relatively large volume, thereby increasing the overall size of the trimmer. Consequently, such trimmers are not sufficiently compact or flexible during use and are inconvenient to carry.

### SUMMARY

In order to address at least one of the above-mentioned problems, the present disclosure provides a dual-purpose razor head structure, which is suitable for being mounted on a hair trimmer. The hair trimmer includes an oscillating motor with a motor shaft. The dual-purpose razor head structure includes an oscillating frame adapted to connect to the motor shaft. A stationary blade holder and a movable blade assembly are connected to the oscillating frame. The oscillating frame is connected to the movable blade assembly and drives the movable blade assembly to reciprocate. A first trimming part and a second trimming part are formed between the movable blade assembly and the stationary blade holder. The first trimming part is configured to shorten hair, and the second trimming part is configured to shave hair at the roots. The first trimming part includes stationary blade teeth provided on the stationary blade holder and movable blade teeth provided on the movable blade assembly, and the stationary blade teeth cooperate with the movable blade teeth. The second trimming part includes a stationary blade mesh provided on the stationary blade holder and a shaving blade strip provided on the movable blade assembly, and the shaving blade strip cooperates with the stationary blade mesh. The present disclosure is provided with a first trimming part and a second trimming part, which can realize two functions of shortening hair and shaving hair at roots, thereby providing diversified functions, simple operation, and high hair-trimming efficiency. In addition, the structure is compact and small in size.

Optionally, the movable blade assembly is disposed between the stationary blade holder and the oscillating frame. The movable blade assembly includes a first movable blade member and a second movable blade member. A limiting mechanism is provided between the first movable blade member and the second movable blade member to make the first movable blade member and the second movable blade member oscillate synchronously. The movable blade teeth are arranged on the first movable blade member, and the shaving blade strip is arranged on the second movable blade member.

Optionally, the limiting mechanism includes a first limiting block provided on the second movable blade member and a first limiting groove provided on the first movable blade member, and the first limiting block is disposed in the first limiting groove for limiting.

Optionally, the oscillating frame is provided with an oscillating part that is connected to the motor shaft and oscillates synchronously. The oscillating part is connected to the second movable blade member and drives the second movable blade member to oscillate synchronously.

Optionally, two first limiting blocks are symmetrically arranged, forming a second limiting groove therebetween. The oscillating part is provided with a connecting groove connected to the motor shaft and a second limiting block corresponding to the second limiting groove. The second limiting block is disposed in the second limiting groove for limiting.

Optionally, two limiting protrusions are symmetrically arranged on the first movable blade member, the first limiting grooves are formed between the two limiting protrusions, the first limiting blocks abut against the limiting protrusions for limiting. A boss is provided on a side of the second limiting block, and a spring tab abuts between the boss and the first movable blade member; a compression spring abuts between the oscillating part and the second movable blade member.

Optionally, the first movable blade member has a plate-like shape, and the first movable blade member is bent to define a receiving recess, and the second movable blade member is disposed in the receiving recess.

Optionally, the first movable blade member is made of a ceramic material, and when the second trimming part is adapted to trim the hair at the roots, the stationary blade holder is provided with a skin-contacting surface that is close to human skin, and the skin-contacting surface is a plane or a curved surface.

Optionally, the stationary blade holder is hingedly connected to the oscillating frame, and two sets of stationary blade teeth are provided symmetrically on two opposite edges of the stationary blade holder, and the stationary blade mesh is located between the two sets of stationary blade teeth.

Compared to existing technologies, the dual-purpose razor head structure of the present disclosure is equipped with a first trimming part and a second trimming part, enabling it to perform two functions of shortening hair and trimming hair at the roots, thereby providing diversified functions, simple operation, and high hair-trimming efficiency. In addition, the structure is compact and small in size. The first and second movable blade members are limited by their own structures, eliminating the need for additional parts to limit their movement, resulting in a simple structure and low production cost. Since the first and second movable blade members are limited and oscillate synchronously, by connecting the oscillating part to the first movable blade member, both blades can be driven to perform reciprocating motion, resulting in a simple and reasonable structure. The first limiting blocks abut against the limiting protrusions to realize effective limiting, preventing relative displacement between the first and second movable blade members during oscillating and ensuring a more stable hair trimming operation. The first movable blade member is made of a ceramic material, which is not prone to overheating during prolonged use, having low lubrication requirements, thereby minimizing the frequency of adding cooling lubricating fluid due to excessive heat.

In addition, the present disclosure further provides a hair trimmer, including the above-mentioned dual-purpose razor head structure. The hair trimmer also has the same advantageous effects as the above-mentioned dual-purpose razor head structure, which will not be described in detail herein.

### BRIEF DESCRIPTION OF THE DRAWINGS

FIG. 1 is a perspective view of a first embodiment of the present disclosure;

FIG. 2 is an enlarged view of part A in FIG. 1;

FIG. 3 is an exploded view of the first embodiment of the present disclosure;

FIG. 4 is an enlarged view of part B in FIG. 3;

FIG. 5 is another exploded view of the first embodiment of the present disclosure;

FIG. 6 is a schematic structural diagram of the skin-contacting surface of the first embodiment of the present disclosure;

FIG. 7 is a perspective view of a second embodiment of the present disclosure;

FIG. 8 is a schematic structural diagram of the skin-contacting surface in the second embodiment of the present disclosure.

Reference signs are as follows: 1: oscillating frame, 101: oscillating part, 1011: connecting groove, 1012: second limiting block, 2: stationary blade holder, 20: positioning pin, 201: first stationary blade holder, 202: second stationary blade holder, 21: stationary blade teeth, 22: stationary blade mesh, 23: skin-contacting surface, 31: movable blade teeth, 32: shaving blade strip, 4: first movable blade member, 41: first limiting groove, 42: receiving recess, 43: limiting protrusion, 5: second movable blade member, 51: first limiting block, 511: second limiting groove, 512: boss, 513: spring tab, 514: guiding bevel, 6: compression spring, and 7: hinge shaft.

### DETAILED DESCRIPTION OF EMBODIMENTS

To make the above-mentioned objectives, features and advantages of the present disclosure more apparent and understandable, the specific embodiments of the present disclosure will be described in detail below with reference to the accompanying drawings.

In the description of the present disclosure, it should be understood that the terms “upper” and “lower” indicating the orientation or positional relationship are based on the orientation or positional relationship when the product is in normal operation.

The terms “first” and “second” are used for descriptive purposes only and should not be construed as indicating or implying relative importance or implicitly specifying the number of technical features indicated. Therefore, a feature defined as “first” or “second” may explicitly or implicitly include at least one of that feature.

### First Embodiment

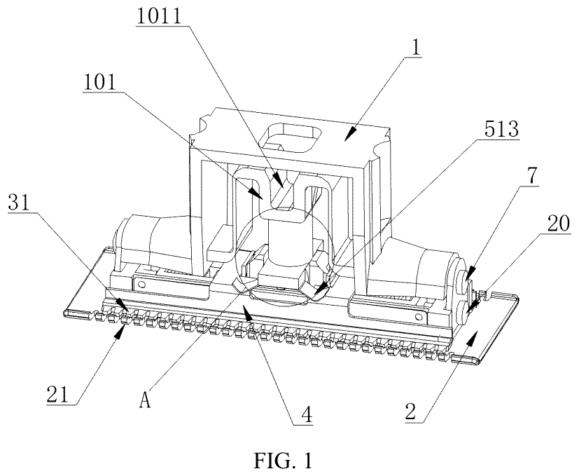

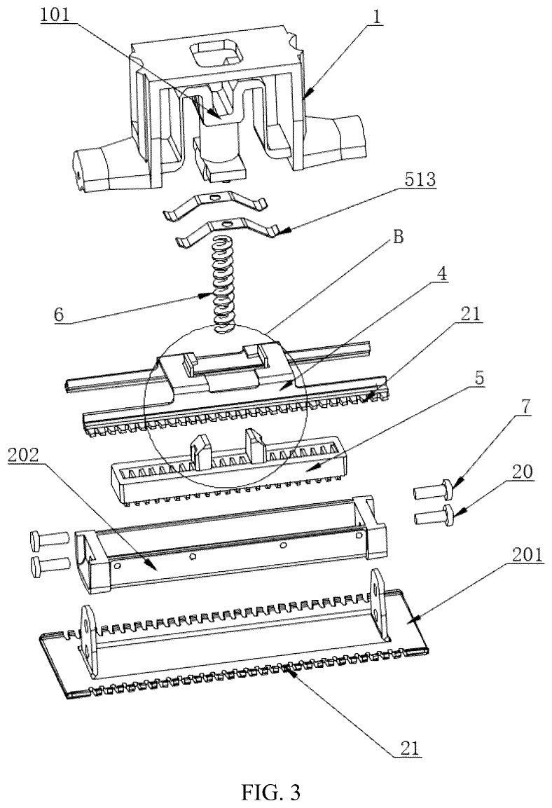

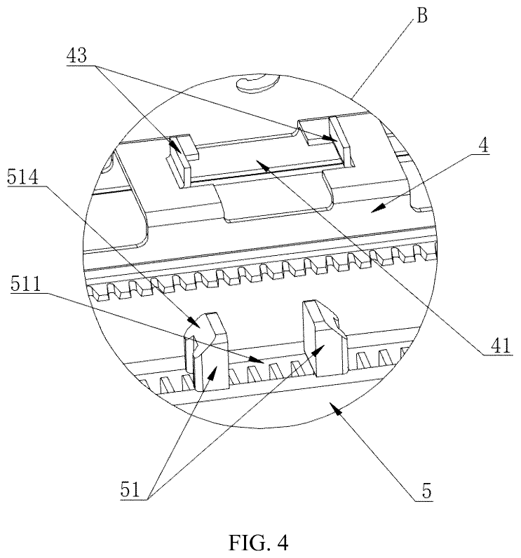

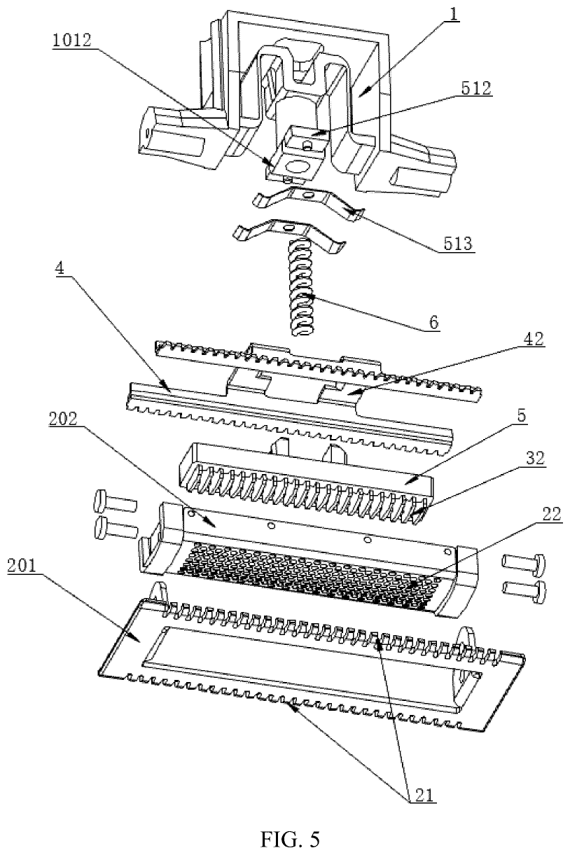

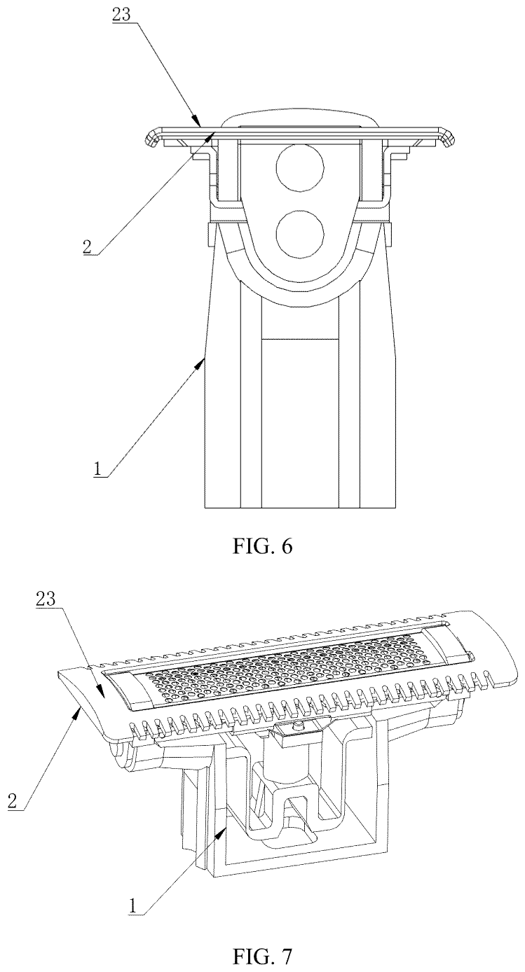

Referring to FIGS. 1-6, the first embodiment of the present disclosure provides a dual-purpose razor head structure suitable for being mounted on a hair trimmer. The hair trimmer includes an oscillating motor with a motor shaft. The dual-purpose razor head structure includes an oscillating frame 1 adapted to connect with the motor shaft. A stationary blade holder 2 and a movable blade assembly are connected to the oscillating frame 1. The oscillating frame 1 is connected to the movable blade assembly and drives the movable blade assembly to perform reciprocating motion. A first trimming part and a second trimming part are formed between the movable blade assembly and the stationary blade holder 2. The first trimming part is configured to shorten hair, and the second trimming part is configured to shave the hair at the roots. The first trimming part includes stationary blade teeth 21 provided on the stationary blade holder 2 and movable blade teeth 31 provided on the movable blade assembly. The stationary blade teeth 21 and the movable blade teeth 31 cooperate with each other. The movable blade teeth 31 are driven to reciprocate relative to the stationary blade teeth 21 by the motor shaft, thereby realizing the function of shortening the hair. The second trimming part includes a stationary blade mesh 22 arranged on the stationary blade holder 2 and a shaving blade strip 32 arranged on the movable blade assembly. The shaving blade strip 32 cooperates with the stationary blade mesh 22. The motor shaft drives the shaving blade strip 32 to reciprocate relative to the stationary blade mesh 22 to achieve the function of shaving the hair at the roots. The present disclosure is provided with a first trimming part and a second trimming part, which can realize the two functions of shortening hair and shaving the hair roots, thereby providing diversified functions, simple operation, and high hair-trimming efficiency. In addition, the structure is compact and small in size. It should be noted that because the thickness of the stationary blade mesh is relatively small, hair such as human beards at the roots can be shaved through cooperation between mesh holes of the stationary blade mesh 22 and the shaving blade strip 32. Preferably, the thickness of the stationary blade mesh 22 is less than 0.1 mm.

Referring to FIGS. 1, 3, and 5, the movable blade assembly is positioned between the stationary blade holder 2 and the oscillating frame 1. The movable blade assembly includes a first movable blade member 4 and a second movable blade member 5, which together achieve the functions of shortening hair and shaving the hair roots. A limiting mechanism is provided between the first movable blade member 4 and the second movable blade member 5 to allow the first movable blade member 4 and the second movable blade member 5 to oscillate synchronously. The movable blade teeth 31 are provided on the first movable blade member 4, and the shaving blade strip 32 is provided on the second movable blade member 5. A plurality of shaving blade strips 32 may be provided, spaced apart along the reciprocating direction of the second movable blade member 5, to improve the shaving effect.

Referring to FIGS. 1-4, the limiting mechanism includes a first limiting block 51 disposed on the second movable blade member 5 and a first limiting groove 41 arranged on the first movable blade member 4. The first limiting block 51 is disposed in the first limiting groove 41 for limiting. The first movable blade member 4 and the second movable blade member 5 are limited by their own structures, without the need for additional parts to limit the first movable blade member 4 and the second movable blade member, resulting in a simple structure and low production cost. The oscillating frame 1 is provided with an oscillating part 101 connected to and oscillates synchronously with the motor shaft. The oscillating part 101 is connected to the second movable blade member 5 and drives the second movable blade member 5 to oscillate synchronously. Since the first movable blade member 4 and the second movable blade member 5 are limited and oscillate synchronously, it is only necessary to connect the oscillating part 101 to the first movable blade member 4 to simultaneously drive the first movable blade member 4 and the second movable blade member 5 to reciprocate, resulting in a simple structure and reasonable design. The first limiting block 51 is provided with a guiding bevel 514 for guiding the first limiting block 51 into the first limiting groove 41, reducing assembly difficulty.

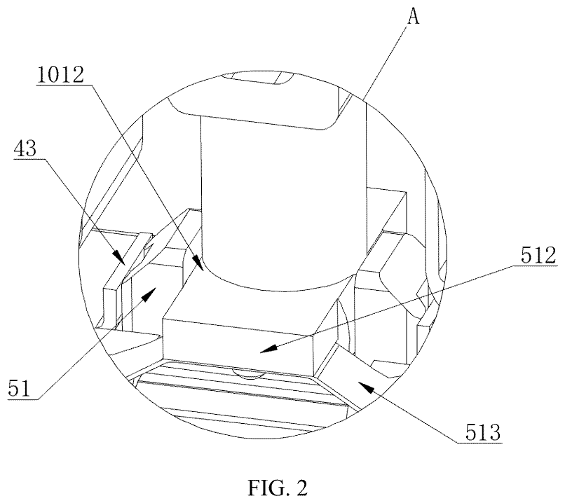

Referring to FIGS. 2-5, two first limiting blocks 51 are symmetrically arranged, and a second limiting groove 511 is formed between the two first limiting blocks 51. The oscillating part 101 is provided with a connecting groove 1011 connected to the motor shaft and a second limiting block 1012 corresponding to the second limiting groove 511. The second limiting block 1012 is disposed in the second limiting groove 511 for limiting. Two limiting protrusions 43 are symmetrically arranged on the first movable blade member 4. A first limiting groove 41 is formed between the two limiting protrusions 43. The first limiting blocks 51 abut against the limiting protrusions 43 for limiting, enabling a good limiting effect, so that the first movable blade member 4 and the second movable blade member 5 are not prone to relative displacement during oscillation, thereby allowing a stable trimming operation. Bosses 512 are provided on the sides of the second limiting block 1012. In this embodiment, two bosses 512 are provided, which are symmetrically arranged on two opposite sides of the second limiting block 1012. A spring tab 513 abuts between each boss 512 and the first movable blade member 4. The elastic force of the spring tabs 513 presses the first movable blade member 4 against the stationary blade holder. After being pressed, the first movable blade member 4 oscillates relative to the stationary blade holder to achieve the function of shortening the hair. A compression spring 6 abuts between the oscillating part 101 and the second movable blade member 5. The elastic force of the compression spring 6 presses the second movable blade member 5 against the stationary blade holder. After being pressed, the second movable blade member 5 oscillates relative to the stationary blade holder to achieve the function of shaving the hair roots.

Referring to FIGS. 1, 3, 5, and 6, the first movable blade member 4 has a plate-like shape, occupying little space after assembly, resulting in a compact overall razor head structure. The first movable blade member 4 is bent to form a receiving recess 42, within which the second movable blade member 5 is placed, resulting in a compact and small-sized structure. The first movable blade member 4 is made of a ceramic material, which is not prone to overheating during prolonged use, requiring less lubrication and reducing the frequency of adding cooling lubrication fluid due to excessive heat. When the second trimming part is configured to trim the hair roots, the stationary blade holder 2 has a skin-contacting surface 23 close to human skin, which is planar, facilitating the trimming of hair roots in relatively flat areas of the human body. The stationary blade holder 2 and the oscillating frame 1 are hingedly connected via a hinge shaft 7. This allows the stationary blade holder 2 to rotate at a certain angle relative to the oscillating frame 1 during use, enabling the stationary blade holder 2 to rotate adaptively when shaving the hair roots, thus better conforming to the skin and improving the trimming effect. Two sets of stationary blade teeth 21 may be provided, symmetrically distributed along two opposite edges of the stationary blade holder 2, and the stationary blade mesh 22 is located between the two sets of stationary blade teeth 21. The stationary blade holder 2 includes a first stationary blade holder 201 and a second stationary blade holder 202, which are fixed together by a positioning pin 20. The stationary blade teeth 21 are arranged on the first stationary blade holder 201, and the stationary blade mesh 22 is arranged on the second stationary blade holder 202.

### Second Embodiment

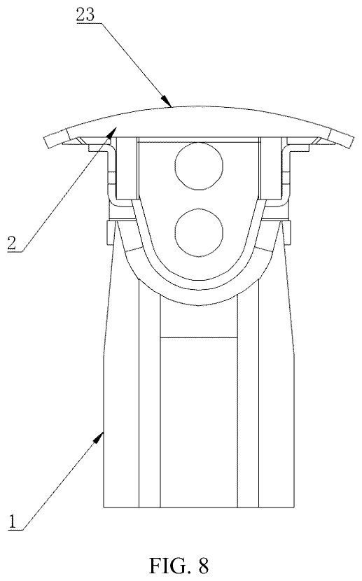

Referring to FIGS. 7 and 8, the difference between the second embodiment and the first embodiment is that the skin-contacting surface 23 is a curved surface, which better conforms to curved, in particular concave areas of the human face and head, thus improving the trimming effect.

The dual-purpose razor head structure of the present disclosure is provided with a first trimming part and a second trimming part, which can realize two functions of shortening hair and shaving the hair roots, thereby providing diversified functions, simple operation, and high hair-trimming efficiency. In addition, the structure is compact and small in size. The first and second movable blade members are limited by their own structures, without the need for additional parts to limit the first and second movable blade members. The structure is simple and the production cost is low. Since the first and second movable blade members are limited and oscillate synchronously, it is only necessary to connect the oscillating part to the first movable blade member to simultaneously drive the first and second movable blade members to reciprocate, resulting in a simple structure and reasonable design. The first limiting blocks abut against the limiting protrusion for limiting, enabling a good limiting effect, so that the first and second movable blade members are not prone to relative displacement during oscillation, thereby allowing a stable trimming operation. The first movable blade member is made of a ceramic material, which is not prone to overheating during prolonged use, having low lubrication requirements, thereby reducing the frequency of adding cooling lubrication fluid due to excessive heat.

In addition, the present disclosure further provides a hair trimmer, including the above-mentioned dual-purpose razor head structure. The hair trimmer also has the same advantageous effects as the above-mentioned dual-purpose razor head structure, which will not be described in detail herein.

The above description shows only preferred embodiments of the present disclosure. It should be noted that for those skilled in the art, several improvements and modifications can be made without departing from the technical principles of the present disclosure, and these improvements and modifications fall within the scope of protection of the present disclosure.

What is claimed is:

1. A dual-purpose razor head structure, suitable for being mounted on a hair trimmer, the hair trimmer comprising an oscillating motor having a motor shaft, wherein the dual-purpose razor head structure comprises an oscillating frame (1) adapted to connect to the motor shaft, a stationary blade holder (2) and a movable blade assembly are connected to the oscillating frame (1), the oscillating frame (1) is connected to and drive the movable blade assembly to reciprocate, a first trimming part and a second trimming part are formed between the movable blade assembly and the stationary blade holder (2), the first trimming part is configured to shorten hair, and the second trimming part is configured to shave the hair at roots;
wherein the first trimming part includes stationary blade teeth (21) arranged on the stationary blade holder (2) and movable blade teeth (31) arranged on the movable blade assembly, the stationary blade teeth (21) cooperate with the movable blade teeth (31); and
wherein the second trimming part includes a stationary blade mesh (22) arranged on the stationary blade holder (2) and a shaving blade strip (32) arranged on the movable blade assembly, and the shaving blade strip (32) cooperates with the stationary blade mesh (22).

2. The dual-purpose razor head structure according to claim 1, wherein the movable blade assembly is disposed between the stationary blade holder (2) and the oscillating frame (1), the movable blade assembly includes a first movable blade member (4) and a second movable blade member (5), with a limiting mechanism provided therebetween to make the first movable blade member (4) and the second movable blade member (5) oscillate synchronously, the movable blade teeth (31) are arranged on the first movable blade member (4), and the shaving blade strip (32) is arranged on the second movable blade member (5).

3. The dual-purpose razor head structure according to claim 2, wherein the limiting mechanism includes a first limiting block (51) arranged on the second movable blade member (5) and a first limiting groove (41) arranged on the first movable blade member (4), and the first limiting block (51) is placed in the first limiting groove (41) for limiting.

4. The dual-purpose razor head structure according to claim 3, wherein the oscillating frame (1) is provided with an oscillating part (101) that is connected to and oscillates synchronously with the motor shaft, and the oscillating part (101) is connected to the second movable blade member (5) and drives the second movable blade member (5) to oscillate synchronously.

5. The dual-purpose razor head structure according to claim 4, wherein two first limiting blocks (51) are symmetrically arranged, a second limiting groove (511) is formed between the two first limiting blocks (51), the oscillating part (101) is provided with a connecting groove (1011) connected to the motor shaft and a second limiting block (1012) corresponding to the second limiting groove (511), and the second limiting block (1012) is disposed in the second limiting groove (511) for limiting.

6. The dual-purpose razor head structure according to claim 5, wherein two limiting protrusions (43) are symmetrically arranged on the first movable blade member (4), the first limiting groove (41) is formed between the two limiting protrusions (43), the first limiting blocks (51) abut against the limiting protrusions (43) for limiting, a boss (512) is provided on a side of the second limiting block (1012), and a spring tab (513) abuts between the boss (512) and the first movable blade member (4); a compression spring (6) abuts between the oscillating part (101) and the second movable blade member (5).

7. The dual-purpose razor head structure according to claim 2, wherein the first movable blade member (4) has a plate-like shape and is bent to define a receiving recess (42), and the second movable blade member (5) is placed in the receiving recess (42).

8. The dual-purpose razor head structure according to claim 2, wherein the first movable blade member (4) is made of a ceramic material, and when the second trimming part is adapted to trim the roots of the hair, the stationary blade holder (2) has a skin-contacting surface (23) close to human skin, and the skin-contacting surface (23) is a planar or curved surface.

9. The dual-purpose razor head structure according to claim 1, wherein the stationary blade holder (2) is hingedly connected to the oscillating frame (1), two sets of stationary blade teeth (21) are provided, symmetrically distributed along opposite edges of the stationary blade holder (2), and the stationary blade mesh (22) is located between the two sets of stationary blade teeth (21).

10. The dual-purpose razor head structure according to claim 2, wherein the stationary blade holder (2) is hingedly connected to the oscillating frame (1), two sets of stationary blade teeth (21) are provided, symmetrically distributed along opposite edges of the stationary blade holder (2), and the stationary blade mesh (22) is located between the two sets of stationary blade teeth (21).

11. The dual-purpose razor head structure according to claim 3, wherein the stationary blade holder (2) is hingedly connected to the oscillating frame (1), two sets of stationary blade teeth (21) are provided, symmetrically distributed along opposite edges of the stationary blade holder (2), and the stationary blade mesh (22) is located between the two sets of stationary blade teeth (21).

12. The dual-purpose razor head structure according to claim 4, wherein the stationary blade holder (2) is hingedly connected to the oscillating frame (1), two sets of stationary blade teeth (21) are provided, symmetrically distributed along opposite edges of the stationary blade holder (2), and the stationary blade mesh (22) is located between the two sets of stationary blade teeth (21).

13. The dual-purpose razor head structure according to claim 5, wherein the stationary blade holder (2) is hingedly connected to the oscillating frame (1), two sets of stationary blade teeth (21) are provided, symmetrically distributed along opposite edges of the stationary blade holder (2), and the stationary blade mesh (22) is located between the two sets of stationary blade teeth (21).

14. The dual-purpose razor head structure according to claim 6, wherein the stationary blade holder (2) is hingedly connected to the oscillating frame (1), two sets of stationary blade teeth (21) are provided, symmetrically distributed along opposite edges of the stationary blade holder (2), and the stationary blade mesh (22) is located between the two sets of stationary blade teeth (21).

15. The dual-purpose razor head structure according to claim 7 wherein the stationary blade holder (2) is hingedly connected to the oscillating frame (1), two sets of stationary blade teeth (21) are provided, symmetrically distributed along opposite edges of the stationary blade holder (2), and the stationary blade mesh (22) is located between the two sets of stationary blade teeth (21).

16. The dual-purpose razor head structure according to claim 8, wherein the stationary blade holder (2) is hingedly connected to the oscillating frame (1), two sets of stationary blade teeth (21) are provided, symmetrically distributed along opposite edges of the stationary blade holder (2), and the stationary blade mesh (22) is located between the two sets of stationary blade teeth (21).

17. A hair trimmer, comprising a dual-purpose razor head structure and an oscillating motor, the oscillating motor being provided with a motor shaft, wherein the dual-purpose razor head structure comprises an oscillating frame (1) adapted to be connected to the motor shaft, a stationary blade holder (2) and a movable blade assembly are connected to the oscillating frame (1), the oscillating frame (1) is connected to the movable blade assembly and drive the movable blade assembly to reciprocate, a first trimming part and a second trimming part are formed between the movable blade assembly and the stationary blade holder (2), the first trimming part is configured to short hair, the second trimming part is configured to shave the hair at roots;
wherein the first trimming part includes stationary blade teeth (21) arranged on the stationary blade holder (2) and movable blade teeth (31) arranged on the movable blade assembly, the stationary blade teeth (21) cooperate with the movable blade teeth (31); and
wherein the second trimming part includes a stationary blade mesh (22) arranged on the stationary blade holder (2) and a shaving blade strip (32) arranged on the movable blade assembly, and the shaving blade strip (32) cooperates with the stationary blade mesh (22).

18. The hair trimmer according to claim 17, wherein the movable blade assembly is disposed between the stationary blade holder (2) and the oscillating frame (1), the movable blade assembly includes a first movable blade member (4) and a second movable blade member (5), with a limiting mechanism provided therebetween to make the first movable blade member (4) and the second movable blade member (5) oscillate synchronously, the movable blade teeth (31) are arranged on the first movable blade member (4), and the shaving blade strip (32) is arranged on the second movable blade member (5).

19. The hair trimmer according to claim 18, wherein the limiting mechanism includes a first limiting block (51) arranged on the second movable blade member (5) and a first limiting groove (41) arranged on the first movable blade member (4), and the first limiting block (51) is placed in the first limiting groove (41) for limiting.

20. The hair trimmer according to claim 19, wherein the oscillating frame (1) is provided with an oscillating part (101) that is connected to and oscillates synchronously with the motor shaft, and the oscillating part (101) is connected to the second movable blade member (5) and drives the second movable blade member (5) to oscillate synchronously.
